(19) United States
(12) Patent Application Publication
(10) Pub. No.: US 2025/0103681 A1
(43) Pub. Date: Mar. 27, 2025

(54) PROCESSING ELEMENT CONFIGURED TO APPROXIMATE A TRANSCENDENTAL FUNCTION

(71) Applicant: Arm Limited, Cambridge (GB)

(72) Inventor: Olof Henrik Uhrenholt, Lomma (SE)

(73) Assignee: Arm Limited, Cambridge (GB)

(21) Appl. No.: 18/890,214

(22) Filed: Sep. 19, 2024

(30) Foreign Application Priority Data
Sep. 25, 2023 (GB) 2314683.0

(51) Int. Cl. G06F 17/17; G06F 1/03

(52) U.S. Cl. CPC G06F 17/17; G06F 1/0307

(57) ABSTRACT

A processing element is configured to approximate a transcendental function. The processing element comprises an input storage and a look-up storage. The processing element obtains floating-point input data from the input storage representing having an input exponent value and an input mantissa value. The processing element looks up approximation parameters and an output exponent value from the look-up storage, wherein each group of approximation parameters and output exponent value are stored in the look-up storage in association with a respective range of a plurality of ranges that are defined by the input exponent value and the input mantissa value. The ranges cover values of the input exponent value and input mantissa value such that the output exponent value associated with each range does not change by more than a predetermined number. An approximation function is evaluated that approximates the transcendental function based on the looked-up approximation parameters and output exponent.

### CROSS-REFERENCE TO RELATED APPLICATION

This application claims the benefit under 35 U.S.C. § 119 (a) and 37 CFR § 1.55 to United Kingdom patent application no. 2314683.0, filed on Sep. 25, 2023, the entire content of which is incorporated herein by reference.

### TECHNICAL FIELD

The present invention relates to a processing element configured to approximate a transcendental function and a method performed by such a processing element.

### BACKGROUND

Computers are often used to perform mathematical functions. Some operations such as addition and multiplication can be performed straightforwardly by a computer processor. Other functions, referred to as transcendental functions, are not expressible as a finite combination of algebraic operations of addition, subtraction, multiplication and division. In other words, these functions cannot be expressed as solutions to polynomial equations with rational coefficients. Some common transcendental functions include exponential, logarithmic, trigonometric, and hyperbolic functions. Transcendental functions cannot easily be accurately determined by a computer processor.

The values of transcendental functions may be approximated by a computer processor using numerical techniques in order to output a value that is close to or equal to the transcendental function to within a predetermined degree of accuracy.

Accordingly, it is desirable to design a processing element that can efficiently approximate transcendental functions. The present application is particularly concerned with how to efficiently approximate a logarithm function.

### SUMMARY

According to a first aspect of the present invention, there is provided a processing element configured to approximate a transcendental function, the processing element comprising an input storage, a look-up storage, a multiplication unit and an addition unit, wherein the processing element is configured to: obtain floating-point input data representing an input value from the input storage, the floating-point input data representing an input exponent value and an input mantissa value; identify the input exponent value and, in a case that the input exponent value has a predefined value and the input mantissa value lies within a predefined range: look up approximation parameters and an output exponent value from the look-up storage, wherein each group of approximation parameters and output exponent value are stored in the look-up storage in association with a respective range of a plurality of ranges that are defined by one or more of the input exponent value and the input mantissa value, the ranges covering values of the input exponent value and input mantissa value such that the output exponent value associated with each range does not change by more than a predetermined number across each range; and evaluating, using the multiplication unit and the addition unit, an approximation function to generate an output that approximates the transcendental function, based at least in part on the looked-up approximation parameters and output exponent value.

The plurality of ranges may be configured such that a maximum output error that is a difference between the evaluated approximation function and the transcendental function in each range does not exceed the threshold error value.

The processing element may comprise a shifter unit configured to perform an input shift that is at least one of denormal normalization and a sub-division alignment for obtaining the floating-point input data.

For at least one range of the plurality of ranges, the output exponent value may be stored in a same part of a table as an approximation coefficient of the approximation coefficients. Storage may be made available for the output exponent value by reducing a number of bits allocated for storing the approximation coefficient.

The approximation function may be a Taylor expansion.

The predefined value of the input exponent value and the predefined range of the input mantissa value may correspond to output values of the transcendental function close to zero. The predefined input exponent values may be −1 and 0. The predefined input mantissa value range may be [1,2)

In some embodiments, the approximation coefficients are polynomial coefficients and the approximation function is a polynomial function.

Evaluating the approximation function may comprise evaluating the polynomial function using the input mantissa value of the floating-point input data and generating as the output a floating-point output value that has an output mantissa value based on the evaluated polynomial function. The output exponent value may be equal to the looked-up output exponent value.

The predetermined number by which the output exponent does not change by more than may be one.

The transcendental function may be a logarithm function.

In some embodiments, the approximation parameters for each range of the plurality of ranges may have been obtained using at least one of: Remez algorithm, Lenstra-Lenstra-Lovász, and water flooding search.

The look-up storage may be a read-only storage.

According to a second aspect of the present invention there is provided a method performed by a processing element comprising an input storage, a look-up storage, a multiplication unit and an addition unit for implementing approximations to transcendental functions, the method comprising: obtaining floating-point input data representing an input value from the input storage, the floating-point input data representing an input exponent value and an input mantissa value; identifying the input exponent value and, in a case that the input exponent value has a predefined value and the input mantissa value lies within a predefined range: looking up approximation parameters and an output exponent value from the look-up storage, wherein each group of approximation parameters and output exponent value are stored in the look-up storage in association with a respective range of a plurality of ranges that are defined by the input exponent value and the input mantissa value, the ranges covering values of the input exponent value and input mantissa value such that the output exponent value associated with each range does not change by more than a predetermined number; and evaluating, using the multiplication unit and the addition unit, an approximation function to generate an output that approximates the transcendental function, based at least in part on the looked-up approximation parameters and output exponent value.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a graph showing a portion of y=log 2 (x);

FIG. 2 shows a process for approximating a logarithm function;

FIG. 3 is a chart showing a portion of a table stored in a table ROM; and

FIG. 4 schematically illustrates a data processing apparatus.

### DETAILED DESCRIPTION

The present disclosure relates to an improved processor for calculating transcendental functions. As noted in the introduction, logarithm functions are an example of a transcendental function. While a logarithm function cannot be reliably calculated using a polynomial function with rational coefficients, they may be approximated using a polynomial function.

A processing element will now be described that performs a fixed precision calculation using floating point numbers. The processing elements may be a graphics processor (GPU), a central processing unit (CPU) or a neural processing units (NPU). Transcendental functions are also used in cryptographic applications. Accordingly, in other embodiments, a processing unit may be a cryptographic processor.

A floating-point number may be expressed as the product of two parts: a mantissa and an exponent which indicates a power of two. A floating-point number may be expressed as:

$$\pm mantissa \times {2}^{exponent} \qquad equation 1$$

The mantissa represents the actual binary digits of the floating-point number and has 24 bits. The power of two is represented by the exponent. The stored form of the exponent is an 8-bit value from 0 to 255. The actual value of the exponent is calculated by subtracting 127 from the stored value (0 to 255) giving a range of −127 to +128. The numbers of bits are exemplary and, in this case, correspond to FP32 defined in the IEEE-754 standard. Other sizes of floating-point may be used in difference embodiments. For example, FP16 and FP64 are defined in the IEEE-754 standard.

The mantissa is a 24-bit value (representing about seven decimal digits) whose most significant bit (MSB) is always 1 and is, therefore, not stored. There is also a sign bit that indicates whether the floating-point number is positive or negative. This representation of a floating-point number is referred to as the normal form.

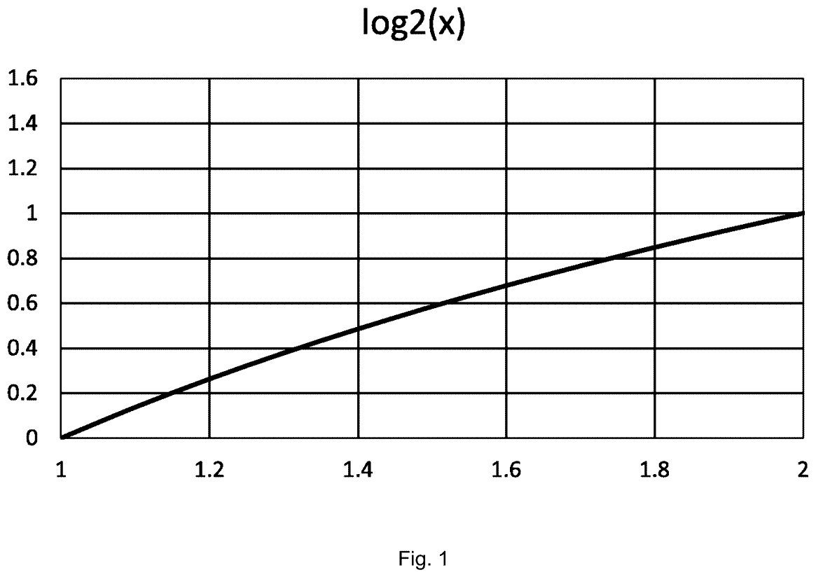

FIG. 1 is a graph showing a portion of:

$$y = log 2 ( x ) \qquad equation 2$$

over a range of x between 1 to 2. As illustrated in FIG. 1, log 2 (1)=0. This means that as an input parameter, x, gets closer to 1, the output parameter, y, becomes small and close to zero.

When calculating logarithms on a processing element, the hardware is fixed. This is to say that the processing element constitutes a fixed-precision pipeline on which calculations need to be performed within the hardware constraints. As the input parameter tends towards 1 and the output parameter, y, tends towards 0 difficulties arise in a fixed precision pipeline because the numbers become very small, and precision may be lost. The same applies when approaching x=1 from the other side i.e., x in the range [0.5,1).

In the floating-point format, the range of x between 1 and 2 is represented by:

$$e = 0 and m in the range [ 1 , 2 ) \qquad equation 3$$

where e is the exponent and m is the mantissa.

In floating point format, the range of x between 0.5 and 1 is represented by:

$$e = - 1 and m in the range [ 1 , 2 ) \qquad equation 4$$

Accordingly, input exponent values 0 and −1 are associated with the output value of the logarithm reaching 0.

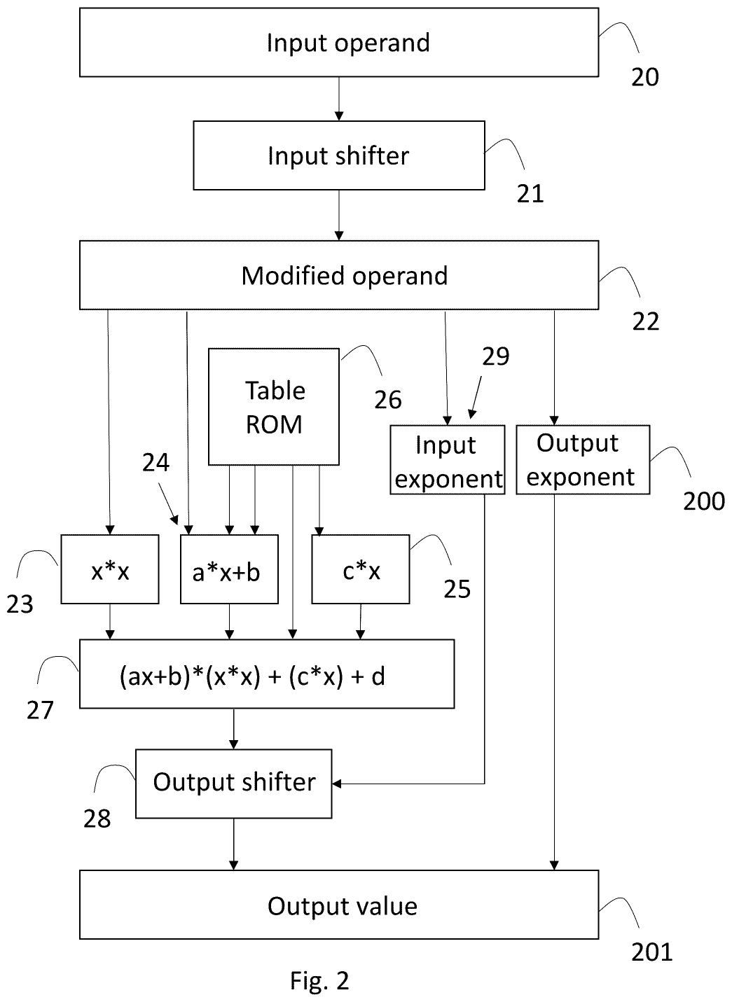

FIG. 2 is a figure showing logic performed by a processing element for estimating a logarithm value. An input operand 20 is received in a 32-bit floating-point format. The input operand 20 is processed by an input shifter 21. The input shifter normalizes denormal input operands and aligns normal input operand values that are close to 1.0 as will now be explained.

A denormalized (or subnormal) floating-point number is a special representation of a real number within the IEEE 754 floating-point standard, which is used in modern computer systems to represent real numbers with finite precision. Denormalized numbers are used to provide gradual underflow, which means that they allow very small numbers (those smaller than the smallest normalized representable number) to be represented with reduced precision rather than being treated as zero.

In contrast to the normalized floating-point number described above in connection with equation 1, a denormalized number is represented as:

$$\pm mantissa \times {2}^{exponent \_ min} \qquad equation 5$$

A difference between normalized and denormalized numbers is that in normalized numbers, the leading bit of the significand is always assumed to be 1 (not stored explicitly), whereas in denormalized numbers, this bit is 0, allowing for values closer to zero to be represented. Denormalized numbers are primarily used to maintain precision as numbers approach zero, providing a smooth transition from finite values to zero as opposed to abrupt underflow.

If the input operand 20 is a denormal, the input shifter 21 normalizes to a normal floating point. This increases the range of the exponent from [−127,128] to [−150,128]. For example, if the denormal number is 0.0001xxxx*2⁻¹²⁷, normalizing this number would lead to 1.xxxx*2⁻¹³¹. The mantissa in this example is shifted 4 places.

As noted above, the input shifter 21 is also configured to perform sub-division alignment. For cases where the input operand 20 is close to 1.0 only bits which carry information need to be considered. As an example, consider the floating-point value 1.00001xxx*2⁰. A fixed-point representation is used in the modified operand 22 in which only the 1xxx part of the mantissa of the input operand 20 is used as the most significant bits of the fixed-point representation which go into the processing pipeline. Hence subdivision alignment is an alignment step which shifts up the input to the first non-zero bit after the leading value of 1.

In general processing through the processing unit proceeds as follows. The input shifter 21 generates floating-point input data in the form of a modified operand 22 as discussed above. The modified operand 22 represents the same input value as input operand 20. In particular, the input shifter 21 may perform one of normalizing denormal input operands and performing sub-division alignment. The modified operand 22 is processed by three processing components 23, 24, 25. The processing units generate components of a polynomial that has been factored as follows:

$$f = a {x}^{3} + b {x}^{2} + c x + d = ( a x + b ) {x}^{2} + c x + d \qquad equation 6$$

As will be explained in more detail below, a table ROM 26 stores parameters a, b, c, and d in connection with a series of input ranges of the modified operand. In one embodiment, coefficient a takes up at most 12 bits, coefficient b takes up at most 16 bits, coefficient c takes up at most 24 bits and coefficient d takes up at most 32 bits.

The first processing component 23 is configured to calculate the modified operand 22 squared. The second processing component 24 is configured to add the coefficient b from the table ROM 26 to the modified operand 22 multiplied by coefficient a from the table ROM 26. The third processing component 25 is configured to multiply the coefficient c from the table ROM 26 by the modified operand 22.

At an assembly component 27, the output of the first processing component 23 is multiplied with the output of the second processing component 24. The result is then added to the output of the third processing component 25 and the coefficient d from the table ROM 26.

An output shifter 28 is provided to shift the result of assembly component 27 based on an input exponent 29. It is noted that:

$$y = log 2 ( x ) = log 2 ( m {2}^{e} ) = log 2 ( m ) + e \qquad equation 7$$

where x is represented in floating-point format by a mantissa m and exponent e as before.

Accordingly, the calculations performed by the first processing component 23, second processing component 24 and third processing component 25 are performed on the mantissa m with a view to evaluating log 2 (m). The input exponent 29 (shown as e in the equation 7 above) is combined with the result from the assembly component 27 in the output shifter 28, which shifts the output of the assembly component 27. In some embodiments the output shifter 28 may shift the output by up-to 7 places in order to produce an output value in floating point format. In some embodiments, the output may be in 8:28 fixed point format.

The result is an output value 201 that is returned for output or further processing. In some cases, the output value 201 may have an output exponent 200 set by the table ROM 26 as explained further below.

If the input exponent of the modified operand is either −1 or 0, the method proceeds in the same way as described above. However, as noted above, there is a problem that the output exponent is likely to vary significantly across the range of the mantissa as the output value 201 gets close to zero. To overcome this problem, the table ROM 26 stores a series of ranges for the modified operand 22 including an output exponent. The output exponent 200 is passed to the output value 201 and does not require handling by the output shifter 28.

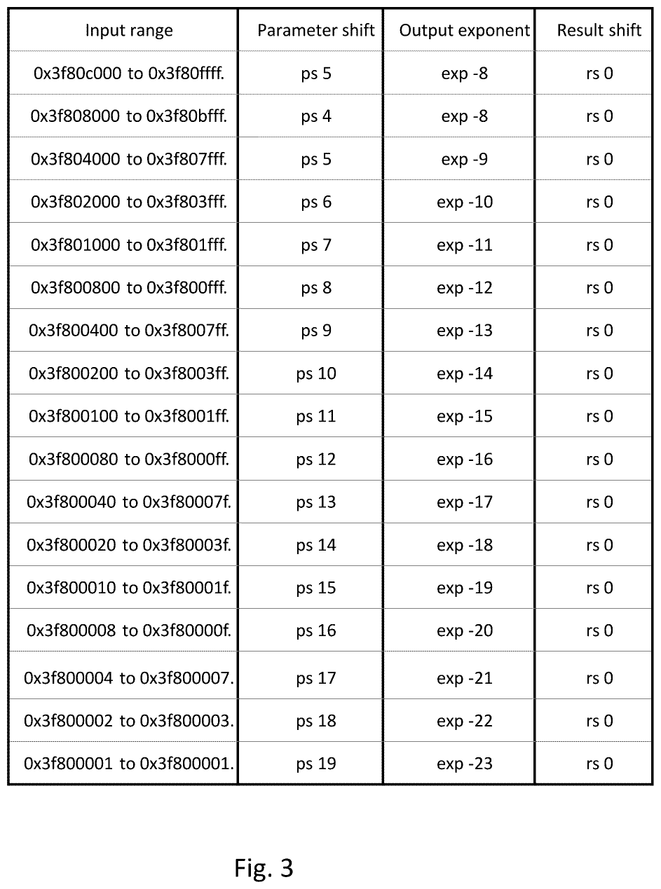

FIG. 3 is a chart showing a portion of a table stored in the table ROM 26. The chart shows an input range, a parameter shift, an output exponent, and a result shift. Values of the coefficients, a, b, c, d, for each range are also stored in the table ROM 26 in connection with each range but are not illustrated. The input range is shown in hexadecimal format and two numbers are shown in the column ‘input range’ representing a start of the range and end of the range. Each hexadecimal number is indicated by ‘0x’. the hexadecimal characters ‘3f8’ indicate, intuitively speaking, ‘1.xxxx . . . ’, and the following 5 symbols are 20 bits representing the values ‘xxxx . . . ’.

The parameter shift, ps, denotes the amount of shifting used in the sub-division alignment performed by the input shifter 21 described above. The output exponent 200 indicates the exponent for the output value 201. The result shift indicates the amount of shifting required by the output shifter 28. It should be noted that for input exponents having a value of either −1 or 0 to which the ranges illustrated in FIG. 3 relate, no shift is required by the output shifter 28. That is to say that the output from these ranges will never become denormal.

At this point a feature of the ranges should be noted. The ranges illustrated in FIG. 3 have been selected so that for each given range of the input operand 20, the output exponent does not vary by more than 1 value. For example, the start of a sub-divided range may begin with at an output exponent of −3 and end with −2. Intuitively speaking, this divides the input domain into smaller ranges as the input operand 20 approaches 1. In this way, the output exponent 200 can be provided from the table ROM 26 to the output value 201. By looking-up the output exponent in Table ROM 26 there is no need to calculate the output exponent and large output shifts by the output shifter 28 can be avoided. Accordingly, a smaller output shifter 28 may be employed which is economical in terms of space on the processing element.

In order to configure a table in the Table ROM 26 to include an appropriate set of ranges and a set of coefficients for approximating a logarithm within the range, the following approaches may be taken.

The ranges in general are selected such that the cubic polynomial approximation of the logarithm throughout the range is accurate to within a predetermined error margin of the true value. In one example the ranges may be selected so that the precision across the entire 32-bit floating-point domain does not exceed 3 ulp, where ulp stands for unit in last position. If a precision is n ULP, for an operation with infinitely precise result x, the value returned must be in the range [x-n×ulp (x), x+n×ulp (x)].

The function ulp (x) is defined as the minimum possible distance between non-equal, finite floating-point numbers a and b such that a≤x≤b. Accordingly, ulp (x) may be expressed as ulp (x)=min_{a,b}|b−a|.

For ranges that are stored in the table ROM 26 for the case in which the input exponent is either −1 or 0 an additional criterion is applied. In these cases, each range should not be associated with output values that crosses more than one output exponent as explained above.

Many different approaches could be adopted in order to identify suitable ranges of the mantissa and exponent. In one example in connection with exponent values of −1 or 0, each part of the range may be successively subdivided until both the polynomial approximation provides the desired accuracy and the output exponents identified by performing approximation of the logarithm at the start and end of the proposed range do not vary by more than 1.

Once the ranges are identified, identifying the coefficients of a polynomial to approximate the logarithm for a particular range may be done in several ways. In one example, Remez algorithm is a known algorithm for finding a polynomial fit which minimizes absolute error over a specified range. In another approach the Lenstra-Lenstra-Lovász (LLL) algorithm may be used on lattice points generated by a logarithm over a particular range and the resulting base vectors may be used to generate a polynomial approximation. In yet a further approach, a computational search may be performed for the optimum polynomial coefficients a, b, c and d. These coefficients form a multidimensional search space, and an energy function can be defined as deviation from the true value of the logarithm being approximated. A local optimization, such as gradient decent, may be applied to the coefficients to find a locally optimum set of coefficients. These values may then be further perturbed to look for other better non-local coefficient solutions. This approach may be referred to as a ‘water flooding search’.

In some embodiments, the table stored in the table ROM 26 may be optimized for efficient storage. For a logarithm close to 1.0, the Taylor expansion of a logarithm would be:

$$log 2 ( 1 + z ) = z - \frac{{z}^{2}}{2} + \frac{{z}^{3}}{3} + O ( {z}^{4} ) \qquad equation 8$$

Accordingly, close to 1.0 (i.e., where z is small) we expect that coefficient a, the third-degree polynomial coefficient, found by the methods described above is going to be small. In other words, log 2 (x) is close to linear near x=1 accordingly the coefficient a representing a cubic component will be small. The table ROM 26 in the processing element has 12 bits for the third-degree coefficient, a, as described above. In practice, the actual coefficient stored only occupies a few bits for ranges close to x=1. Accordingly, some of the 12 bits of storage allocated to storage of coefficient a may be repurposed to store the output exponent. Accordingly, the output exponent may be stored in the same part of the table in the table ROM 26 as the third-degree coefficient, a. This allows a very efficient way to store the output exponents that does not require a separate table in the table ROM 26. In some embodiments, either 3 bits or 6 bits may be taken from storage of the ‘a’ coefficient to store the output coefficient.

An advantage of the methods previously described is that the need for a large output shifter is avoided by careful selection of the ranges stored in the table within the table ROM 26. A further advantage is that the logarithm is approximated directly rather than by adopting an approach of manipulating the logarithm function to make it better behaved over the range of the mantissa, [1,2] as has been done in some prior art approaches. By approximating the logarithm directly fewer operations are required resulting in an efficient processor calculation.

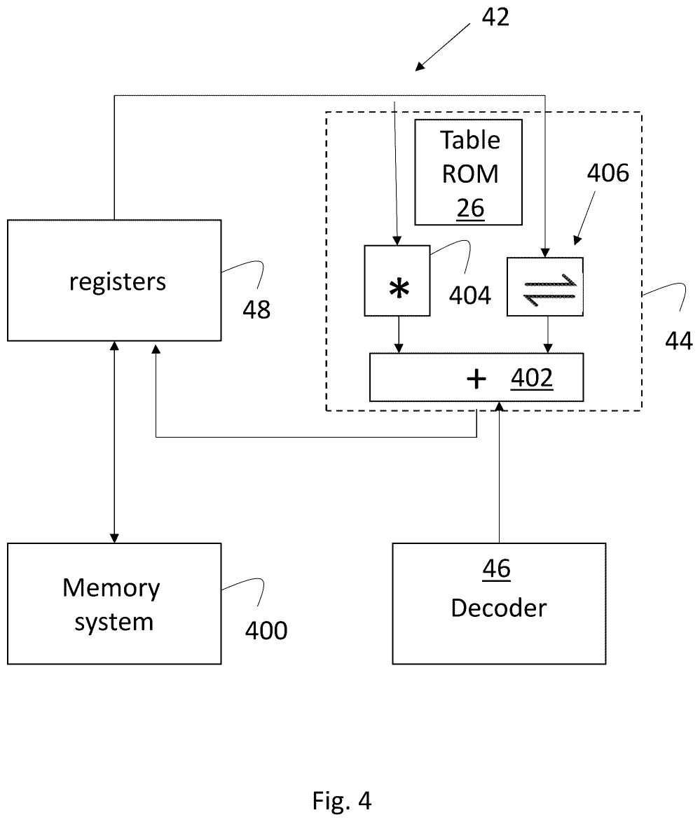

FIG. 4 schematically illustrates a processing element 42 suitable for performing the methods described above. The processing element 42 comprises processing circuitry 44, an instruction decoder 46, a bank of registers 48 and a memory system 400. The memory system 400 includes one or more cache or memory devices. The processing circuit 44 includes a number of processing elements such as the table ROM 26, adders 402, multipliers 404 and shifters 406. When processing data, an instruction to calculate a logarithm value, decoder 46 is responsive to program instructions to generate control signals for controlling the processing circuit 44 to process data stored in the registers 48 and to store processing results in the registers 48. The logic of the process performed has been described above in connection with FIGS. 2 and 3. Under control of the instruction decoder 46 the data processing apparatus 42 may also be controlled to transfer data between the registers 48 and the memory system 400.

The register bank 48 is accessible using multiple different register access sizes. If the registers comprise 64 bits, say, then the registers may be subject to a 64-bit access or a 32-bit access, for example. The logarithmic function described above utilize a 32-bit access.

The shifters 406 are of a finite size. Accordingly, by including the table ROM 26 in the processing circuitry 44 configured as described in the embodiments above, efficient approximation of logarithms may be performed within the fixed precision hardware of the processing circuitry 44.

While in the example of FIG. 4, the processing circuit 44 is illustrated as processing data stored in the registers 48 and storing the results of data processing back to the registers 48, it will be appreciated that any other kind of storage location may be used instead of the registers 48. It will be appreciated that the data processing apparatus 42 and processing circuit 44 may typically include other elements not illustrated in FIG. 1.

The above embodiments are to be understood as illustrative examples of the invention. Further embodiments of the invention are envisaged. For example, in the example above, the approximation of the transcendental function is performed using a cubic polynomial. However, the approximation may be performed using a polynomial of a different order, such as a quadratic or quartic polynomial.

In embodiments described above, the transcendental function is a logarithm function. However, it is clear that the problem described will arise in connection with other transcendental functions whose output values become zero. For example, the same problem could arise when approximating a sine function close to x=0 or an exponential function. In this case, the sine function may again be approximated using a polynomial over different ranges using the techniques described above. By setting up a suitable set of ranges and output exponents the same benefits described above may be obtained when determining other transcendental functions as the function output value gets close to zero.

In the embodiments described above, the ranges stored in the table ROM 26 are selected such that the output exponent does not vary by more than 1 over the defined range. In other embodiments, this requirement could be relaxed to another predetermined number, such as 2. In such embodiments, the output shifter 28 would need to compensate for the extra range in outputs that may result from the assembly unit 27.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A processing element configured to approximate a transcendental function, the processing element comprising an input storage, a look-up storage, a multiplication unit and an addition unit, wherein the processing element is configured to:
obtain floating-point input data representing an input value from the input storage, the floating-point input data representing an input exponent value and an input mantissa value;
identify the input exponent value and, in a case that the input exponent value has a predefined value and the input mantissa value lies within a predefined range:
look up approximation parameters and an output exponent value from the look-up storage, wherein each group of approximation parameters and output exponent value are stored in the look-up storage in association with a respective range of a plurality of ranges that are defined by one or more of the input exponent value and the input mantissa value, the ranges covering values of the input exponent value and input mantissa value such that the output exponent value associated with each range does not change by more than a predetermined number across each range; and
evaluating, using the multiplication unit and the addition unit, an approximation function to generate an output that approximates the transcendental function, based at least in part on the looked-up approximation parameters and output exponent value.

2. A processing element according to claim 1, wherein the plurality of ranges is configured such that a maximum output error that is a difference between the evaluated approximation function and the transcendental function in each range does not exceed the threshold error value.

3. A processing element according to claim 1, wherein the processing element comprises a shifter unit configured to perform an input shift that is at least one of denormal normalization and a sub-division alignment for obtaining the floating-point input data.

4. A processing element according to claim 1, wherein for at least one range of the plurality of ranges, the output exponent value is stored in the same part of a table as an approximation coefficient of the approximation coefficients, wherein storage is made available for the output exponent value by reducing a number of bits allocated for storing the approximation coefficient.

5. A processing element according to claim 1, wherein the approximation function is a Taylor expansion.

6. A processing element according to claim 1 wherein the predefined value of the input exponent value and the predefined range of the input mantissa value correspond to output values of the transcendental function close to zero.

7. A processing element according to claim 1, wherein the predefined input exponent values are −1 and 0, and wherein the predefined input mantissa value range is (1,2).

8. A processing element according to claim 1, wherein the approximation coefficients are polynomial coefficients, and the approximation function is a polynomial function.

9. A processing element according to claim 8, wherein evaluating the approximation function comprises evaluating the polynomial function using the input mantissa value of the floating-point input data and generating as the output a floating-point output value that has an output mantissa value based on the evaluated polynomial function and an output exponent value equal to the looked-up output exponent value.

10. A processing element according to claim 1, wherein the predetermined number is one.

11. A processing element according to claim 1, wherein the transcendental function is a logarithm function.

12. A processing element according to claim 1, wherein the approximation parameters for each range of the plurality of ranges have been obtained using at least one of: Remez algorithm, Lenstra-Lenstra-Lovász, and water flooding search.

13. A processing element according to claim 1 wherein the look-up storage is a read-only storage.

14. A method performed by a processing element comprising an input storage, a look-up storage, a multiplication unit and an addition unit for implementing approximations to transcendental functions, the method comprising:
obtaining floating-point input data representing an input value from the input storage, the floating-point input data representing an input exponent value and an input mantissa value;
identifying the input exponent value and, in a case that the input exponent value has a predefined value and the input mantissa value lies within a predefined range:
looking up approximation parameters and an output exponent value from the look-up storage, wherein each group of approximation parameters and output exponent value are stored in the look-up storage in association with a respective range of a plurality of ranges that are defined by the input exponent value and the input mantissa value, the ranges covering values of the input exponent value and input mantissa value such that the output exponent value associated with each range does not change by more than a predetermined number across each range; and
evaluating, using the multiplication unit and the addition unit, an approximation function to generate an output that approximates the transcendental function, based at least in part on the looked-up approximation parameters and output exponent value.
